(19) United States
(12) Patent Application Publication
(10) Pub. No.: US 2013/0320715 A1
(43) Pub. Date: Dec. 5, 2013

(54) CHASSIS PART, IN PARTICULAR JUNCTION ELEMENT OR SUB-FRAME CONTAINING AN ALUMINUM SECONDARY ALLOY

(71) Applicants: Klaus Greven, Hildesheim (DE); Thomas Buschjohann, Nordstemmen (DE)

(72) Inventors: Klaus Greven, Hildesheim (DE); Thomas Buschjohann, Nordstemmen (DE)

(73) Assignee: KSM CASTINGS GROUP GMBH, Hildesheim (DE)

(21) Appl. No.: 13/985,971

(22) PCT Filed: Mar. 9, 2012
(86) PCT No.: PCT/DE12/00240

§ 371 Date: Aug. 16, 2013

(30) Foreign Application Priority Data
Mar. 9, 2011 (DE) 10 2011 013 438.7

(51) Int. Cl. B62D 21/00; B62D 29/00

(52) U.S. Cl. CPC B62D 21/00; B62D 29/00
USPC 296/204

(57) ABSTRACT

The invention relates to a chassis part, in particular a junction element for connecting a plurality of hollow sections in a frame construction, in particular for a motor vehicle, or in particular on a sub-frame for a motor vehicle.

The invention relates to a chassis part, particularly a node element or a subframe, in accordance with the preamble of claim 1.

Frame constructions that comprise hollow profiles that are connected by way of node elements are known as such.

Known frame constructions are, for example, the subframes for motor vehicles also referred to as subframes. The longitudinal and transverse beams forming the frame construction in this connection are known to be produced from light metal, particularly aluminum or aluminum alloys, and are firmly connected with one another by way of a node element or cast node produced from a light metal casting material.

Particularly in the implementation of a subframe for a motor vehicle having longitudinal and transverse beams composed of light metal, with corresponding cast nodes composed of a light metal material, such as, for example, casting aluminum or alloys thereof, known cast nodes can often prove to be disadvantageous with regard to the crash requirements to be met.

If the subframe for a motor vehicle, and here specifically the front-axle subframe, is used for the conversion of crash energy during an accident, known cast nodes can tend to fail prematurely.

The invention is based on the task of further developing a chassis part, particularly a node element according to the preamble of claim 1 or a subframe, with avoidance of the stated disadvantages. Furthermore, the invention is based on the task of producing chassis parts of the type stated initially in more cost-advantageous and environmentally aware manner.

This task is accomplished with a chassis part, particularly a node element or a subframe in accordance with the characteristics of claim 1 or 2. The following description and the dependent claims can relate to particularly practical embodiments of the invention.

The chassis, particularly the node element that is suitable for connection of multiple hollow profiles in a frame construction, particularly for a motor vehicle, or, in particular, the subframe for a motor vehicle, consists of or has a cast piece that consists of at least one Al secondary alloy.

It has been shown that in the event of an accident, node elements configured in this manner, with an Al secondary alloy, do not fail, and furthermore can demonstrate suitable ductility for absorbing crash energy. At the same time, such node element can be produced in more cost-advantageous manner.

Those subframes cast in one piece, as you are disclosed, for example, in the published international applications PCT/DE2006/001582, PCT/DE2008/0817, PCT/DE2008/0018146, PCT/DE2010/000747, PCT/DE2010/000746 or PCT/DE2011/001832, are particularly well suited for being produced from an AL secondary alloy and, at the same time, for meeting predetermined crash requirements. The subframes disclosed there, which are also referred to as subframes or shaft spiders, are characterized in that these are cast in one piece with the accommodations or recesses provided there. The disclosure content of each individual one of the aforementioned applications is incorporated into the present application by means of explicit reference, as belonging to the object of the present application.

Such subframes are attached to the vehicle superstructure, for example to the body and/or to longitudinal beams of a motor vehicle, as pre-assembled units or modules, after having been provided with assemblies or subassemblies.

Subframes for motor vehicles that have two accommodations for the bearing locations for pivot mounting of one each of two wheel guide elements, such as transverse control arms or A-arms, spaced apart from one another in the longitudinal vehicle direction, in each instance, and accommodations for attachment of the front-axle support as a prefinished unit, together with pre-assembled assemblies, on the vehicle superstructure, as well as at least individual ones of the accommodations listed below, for
attachment of the steering box
attachment of the stabilizer
mounting of the hinged support
   whereby the subframe is produced as a component in one piece with these accommodations and connecting them with one another are particularly suitable.

It can be advantageous if the accommodations are connected with one another in such a manner that weight-reducing recesses in the form of perforations and/or cavities open on one side remain in the subframe, without any detrimental influence on the chassis kinematics. It can be advantageous if at least individual ones of the accommodations are integrated into the subframe and/or connected with one another, at least in part, by way of rod-shaped and/or surface-shaped connection elements. It can be advantageous if at least individual ones of the accommodations are integrated and/or connected with one another, at least in part, by way of open-profile-shaped connection elements, particularly those having an essentially T-, U-, V-, L-, X-, Y-, S-, Z- and/or double-T-shaped cross-section. It can be advantageous if the open-profile-shaped connection elements are oriented differently, preferably horizontally or vertically. It can be advantageous if individual shanks of the open-profile-shaped connection elements are designed as reinforcement ribs. Preferably, the connection elements have additional reinforcement ribs, belts, beads, bulges, crosspieces and/or perforations. It can be advantageous if the rear accommodation, in the direction of travel, for mounting of each of the wheel guide elements, possesses accommodation elements spaced apart from the longitudinal vehicle axis, at least approximately vertically, for engaging around and holding the rear bearing, in the direction of travel, on the wheel guide element, whereby the accommodation elements are connected with one another by way of a U-shaped tab and integrated into the subframe. It can be advantageous if the tab has a reinforced edge, at least in part, preferably on its outside. It can be advantageous if the tab is connected with a first accommodation for attachment means for fixing the subframe in place on the vehicle superstructure, by way of at least one connection element. It can be advantageous if the tabs are connected with the first accommodations, and the first accommodations are connected with one another, by way of a single rod-shaped or open-profile-shaped connection element, whereby the open-profile-shaped connection element preferably has a U-shaped cross-section. It can be advantageous if at least one, preferably two accommodations for attachment means for fixing the exhaust gas system in place are provided on the connection element that connects the first accommodations with one another, preferably on the side facing opposite the direction of travel. It can be advantageous if the accommodations for attachment means for fixing the exhaust gas system in place and/or the first accommodations are integrated into and/or onto the side wall that faces opposite the direction of travel, which is formed by a shank of the U-shaped connection element, and/or onto and/or into a planar reinforcement lip that follows it. It can be advantageous if the connection element that connects the first accommodations with one another has a planar, essentially horizontally disposed reinforcement lip on its underside, in and/or opposite the direction of travel. It can be advantageous if reinforcement ribs are provided within the profile-shaped connection element that connects the accommodations, tabs and/or first accommodations, which ribs lead, preferably in a straight line or in zigzag shape, from one side wall to the other side wall and/or preferably from the accommodations disposed in and/or on the one side wall, preferably at a slant and/or preferably in the opposite direction to the opposite side wall. It can be advantageous if the tab connecting the accommodation elements is connected with the accommodation disposed in the direction of travel, for attachment of the steering box, by way of a connection element. It can be advantageous if the accommodation for attachment of the steering box is connected, by way of a preferably at least partly rod-shaped connection element, with the second accommodation, disposed in the direction of travel, for attachment of the subframe on the vehicle superstructure, which accommodation in turn is connected, preferably integrated into a crossbeam, directly with the front accommodation, in the direction of travel, for mounting of each of the wheel guide elements. Preferably, one of the accommodations for attachment of the stabilizer is fastened onto the connection element that connects the accommodation for attachment of the steering box with the second accommodation or the crossbeam. It can be advantageous if the front accommodation, in the direction of travel, for mounting each of the wheel guide elements, possesses two accommodation elements that are spaced apart at least approximately in the longitudinal vehicle axis, to hold the front bearing, in the direction of travel, on the wheel guide element, surrounding it in U shape, whereby the one accommodation element preferably follows the crossbeam directly, and the other accommodation element is integrated into the short shank of an L-shaped tab that preferably follows the crossbeam with its end that does not have the accommodation element. Preferably, the tab has a reinforced edge at least in part, preferably on its outside. It can be advantageous if the crossbeam has a recess that is introduced on one or both sides. It can be advantageous if the crossbeam has a recess that passes through. An advantageous embodiment of the invention provides that an accommodation for attachment of the stabilizer is provided within the recess, which accommodation is connected with the inner wall of the crossbeam, preferably by way of a crosspiece, in the case of a continuous cavity, or, in the case of a non-continuous cavity, is integrated into the remaining surface and preferably disposed directly on the inside wall of the crossbeam and/or preferably provided with at least one reinforcement rib and connected with the inside wall or walls or reinforcement surfaces of the crossbeam. It can be advantageous if the subframe has a reinforcement element that connects the crossbeams, in the transverse direction, in which or on which element the accommodation for mounting of the hinged support is disposed. It can be advantageous if the reinforcement element is configured in rod shape. It can be advantageous if the reinforcement element is configured in the shape of an open profile, particularly with an essentially T-, U-, V- or L-shaped cross-section, whereby preferably, the borders or edges of the reinforcement element are reinforced. Preferably, the reinforcement element has at least one, preferably two reinforcing slanted surfaces, namely at least one on each side of the accommodation, in each instance, and connected with it, in the region of the accommodation for mounting of the hinged support, which surface preferably drops downward from an essentially horizontally disposed partial surface of the reinforcement element, opposite the direction of travel. It can be advantageous if one or more horizontally disposed, planar reinforcement lips are disposed on the reinforcement element, on the side facing in and/or opposite to the direction of travel. Preferably, the horizontally disposed reinforcement lip is configured in level manner. It can be advantageous if the horizontally disposed reinforcement lip is disposed in a plane below the bores provided in the accommodation elements. It can be advantageous if one of the accommodations for attachment of the steering box is connected with the reinforcement element by way of a preferably rod-shaped connection element. Preferably, the first accommodation for attachment of the subframe on the vehicle superstructure forms the rear end of the subframe. It can be advantageous if the accommodation for mounting of the hinged support has a connection element that runs in the direction of one of the first accommodations and is directly or indirectly connected with the latter. It can be advantageous if the accommodation for mounting of the hinged support is connected with one of the accommodations for attachment of the steering box, by way of a connection element. It is advantageous if the reinforcement element has node points on the ends that lead to the crossbeams, at which points at least individual, preferably multiple, preferably rod-shaped connection elements come together. Preferably, the subframe has two accommodations for attachment of the steering box. It can be advantageous if the accommodations for attachment of the steering box and/or the accommodations for attachment of the stabilizer are fastened onto the rod-shaped connection elements by way of crosspieces. It can be advantageous if at least individual ones of the accommodations are integrated into the subframe in framework manner, by way of rod-shaped connection elements. As a result, material is saved, for one thing, and thereby weight of the vehicle itself, and fuel is also saved, and for another, in this way the transport costs and the sprung masses can also be reduced. The rod-shaped connection elements, which delimit essentially material-free compartments, ensure the required rigidity, in this connection, without any detrimental influence on the vehicle kinematics. In this regard, the rod-shaped connection elements can also be referred to as rod-shaped reinforcement elements. When accommodations are spoken of within the scope of the present invention, this term also includes recesses. A further development of the invention provides that two, preferably four, particularly preferably six, further particularly preferably eight, further particularly preferably ten of the accommodations are integrated into the subframe, in framework manner, by way of rod-shaped connection elements, preferably directly connected with one another. In this way, further weight can advantageously be saved, whereby the required rigidity of the subframe is maintained. By means of such a configuration, optimal strength values can be implemented with the lowest possible use of material. It can be advantageous if the rear accommodation, in the direction of travel, for mounting each of the wheel guide elements, possesses accommodation elements spaced apart from the longitudinal vehicle axis, at least approximately vertically, to hold the rear bearing, in the direction of travel, on the wheel guide element, surrounding it, whereby preferably, each accommodation. element is integrated into the subframe, by way of at least one, preferably by way of at least two rod-shaped connection elements. Such a low-material accommodation fulfills its task without any negative influence on the required integration into the subframe. Preferably, at least one, preferably each accommodation element is is connected with a first accommodation for attachment means for fixing the subframe in place on the vehicle superstructure, by way of a rod-shaped connection element. It can be advantageous if at least one accommodation element is connected with the front accommodation, in the direction of travel, for mounting of each of the wheel guide elements, by way of a rod-shaped connection element, whereby the rod-shaped connection element preferably runs approximately in the longitudinal vehicle direction. It can be advantageous if the front accommodation, in the direction of travel, for mounting of each of the wheel guide elements, possesses at least two accommodation elements spaced apart at least approximately in the longitudinal vehicle axis, for holding the front bearing, in the direction of travel, on the wheel guide element, surrounding it in U shape. The subframe advantageously has at least one reinforcement element, in the transverse direction, between the front accommodations, in the direction of travel, for mounting of each of the wheel guide elements, preferably in the form of a horizontally disposed surface element. Such a reinforcement element absorbs the forces that act on the aforementioned accommodations in the transverse direction. Because the reinforcement element is configured in planar manner, the rigidity of the front accommodation element, in the direction of travel, is furthermore increased, with the least possible use of material. Furthermore, such a reinforcement element can be disposed in such a manner that other assemblies, particularly engine and transmission, can be positioned close to the subframe. In this way, less construction space is required. The horizontally disposed surface element is preferably configured to be level. The edge of the surface element that faces in the direction of travel can, additionally or alternatively, have an indentation in the shape of a half oval. It can be advantageous if the horizontally disposed surface element is disposed in a plane below the bores provided in the accommodation elements. Assemblies, particularly engine and transmission, can thereby be positioned very close to the subframe, so that less construction space is required in the vehicle. Preferably, a first accommodation for attachment of the subframe is provided on the vehicle superstructure, which accommodation forms the rear end of the subframe, in the direction of travel. Preferably, a second accommodation is provided for attachment of the subframe on the vehicle superstructure, which accommodation is integrated into a crossbeam and disposed in the immediate region of the front accommodation, in the direction of travel. The subframe advantageously has an approximately central, planar reinforcement element that follows the accommodation for mounting of the hinged support, at least in part, and widens opposite to the direction of travel. Optimal strength values with the least possible use of material can be implemented by such a configuration, whereby such a configuration particularly counteracts vertical vibrations. Preferably, the planar reinforcement element is delimited, at least in part, by reinforcement ribs. It can be advantageous if the planar reinforcement element forms a type of bulge toward the rear edge, opposite the direction of travel, which bulge is configured to be hollow on its underside and possesses a V-cross-section. By means of such a configuration, optimal strength values can be implemented with the least possible use of material. The planar reinforcement element advantageously has node points at the rear edge, opposite the direction of travel, at which points at least individual, preferably multiple rod-shaped connection elements run together. An advantageous embodiment of the invention provides that the first accommodation for attachment of the subframe on the vehicle superstructure is connected with the planar reinforcement element by way of at least one rod-shaped connection element. It can be advantageous if at least one reinforcement rib is provided on the planar reinforcement element, which rib is preferably disposed, in the longitudinal vehicle direction, at least in part between the rear edge of the planar reinforcement element and the accommodation for mounting of the hinged support. It can be advantageous if the surface area of the compartments delimited by the rod-shaped connection elements, in a top view of the subframe, is greater than the non-continuous surface area of the subframe in a top view of the subframe, preferably at least greater than the non-continuous surface area of the reinforcement element in a top view of the subframe. It can be advantageous if the subframe has only two accommodations left for attachment of the steering box. It can be advantageous if the accommodations for attachment of the steering box and/or the accommodations for attachment of the stabilizer are fastened onto the rod-shaped connection elements by way of crosspieces.

It can be advantageous if the Al secondary alloy is an Al—Si secondary alloy, preferably an AlSiMg or an AlSiCu alloy. Al—Si secondary alloys belong, in the present case, to the Al secondary alloys preferably used here, because of the good combination of mechanical and casting technology properties.

Al secondary alloys can advantageously be produced in particularly economical manner, and have a correspondingly good CO₂ balance.

It can be advantageous if the Al secondary alloy has a Si content of maximally 12 wt.-%, preferably of maximally 11 wt.-%.

It can be advantageous if the Al secondary alloy has a Si content of at least 3 wt.-%, preferably of at least 5 wt.-%, particularly preferably of at least 7 wt.-%.

It can be advantageous if the Al secondary alloy has a Mg content of maximally 0.6 wt.-%, preferably of maximally 0.5 wt.-%, particularly preferably of maximally 0.4 wt.-%.

It can be advantageous if the Al secondary alloy has a Mg content of at least 0.2 wt.-%, preferably of at least 0.25 wt.-%.

It can be advantageous if the Al secondary alloy has an Fe content of maximally 0.8 wt.-%, preferably of maximally 0.7 wt.-%, particularly preferably of maximally 0.6 wt.-%.

It can be advantageous if the Al secondary alloy has an Fe content of at least 0.2 wt.-%, preferably of at least 0.3 wt.-%.

It can be advantageous if the Al secondary alloy has a Cu content of maximally 0.6 wt.-%, preferably of maximally 0.5 wt.-%.

It can be advantageous if the Al secondary alloy has a Mn content of less than 0.34*Fe^{-0.49} wt.-%. The Fe content as the basis, with an exponent of −0.49, multiplied by 0.34 in wt.-%, results in the maximally provided Mn content in the Al secondary alloy.

It can be advantageous if the cast piece consists of the secondary alloy AlSi7Mg, preferably in the heat treatment state T5 or T6.

It can also be advantageous if the cast piece consists of the secondary alloy EN AC-AlSi7Mg, preferably in the heat treatment state T5 or T6.

It can be advantageous if the cast piece consists of the secondary alloy AlSi10Mg, preferably in the heat treatment state T5 or T6.

It can also be advantageous if the cast piece consists of the secondary alloy EN AC-AlSi10Mg(a), preferably in the heat treatment state T5 or T6.

It can also be advantageous if the cast piece consists of the secondary alloy EN AC-AlSi10Mg(b), preferably in the heat treatment state T5 or T6.

It can also be advantageous if the cast piece consists of the secondary alloy EN AC-AlSi10Mg(Cu), preferably in the heat treatment state T5 or T6.

It can also be advantageous if the cast piece consists of the secondary alloy AlSi6Cu4, preferably in the heat treatment state T5.

It can also be advantageous if the cast piece consists of the secondary alloy AlSi8Cu3, preferably in the heat treatment state T5.

It can also be advantageous if the cast piece consists of the secondary alloy EN AC-AlSi9Cu3(Fe), preferably in the heat treatment state T5 or T6.

It can also be advantageous if the cast piece consists of the secondary alloy EN AC-AlSi8Cu3, preferably in the heat treatment state T5 or T6.

It can also be advantageous if the cast piece consists of the secondary alloy EN AC-AlSi6Cu4, preferably in the heat treatment state T5 or T6.

In order to improve the requirements in the event of a crash, it can be practical if the chassis part, particularly the node element or the subframe, additionally has at least one reinforcement element.

It is advantageous if the cast part and the at least one reinforcement part are joined together with force fit, shape fit and/or material fit, preferably cast in one piece.

It is practical if the cast piece is produced using the die-casting method.

However, it can also be advantageous if the cast piece is produced using the gravity die-casting method.

Preferably, the cast piece has one or more reinforcement ribs, belts, beads, bulges, crosspieces and/or reinforcement perforations, particularly in the highly stress-resistant region.

It can be advantageous if the cast piece is heat-treated.

It can be advantageous if the cast piece is heat-treated in multiple stages, whereby the multi-stage character is preferably composed of solution annealing, subsequent rapid cooling, and final aging.

It can be advantageous if the cast piece is solution-annealed at temperatures between 480° and 550° C., preferably between 490° and 540° C., particularly preferably between 520° and 540° C.

It can be advantageous if the cast piece is solution-annealed for 1 to 5 hours, preferably 1 to 4 hours, particularly preferably 1 to 3 hours.

It can be advantageous if the cast piece is aged at temperatures between 150° and 250° C.

It can be advantageous if the cast piece is aged for 2 to 6 hours.

It can be advantageous if the cooling rate amounts to more than 1.5 Kelvin/second, preferably more than 2 Kelvin/second, particularly preferably more than 5 Kelvin/second.

It can be advantageous if the cast piece has an elongation to rupture (A) of at least 4%.

It can be advantageous if the cast piece is heat-treated to achieve the state T6.

However, it can also be advantageous if the cast piece is heat-treated to achieve the state T5.

The aforementioned frame construction can advantageously be a structural part of a vehicle body, such as, for example, a front-axle support, rear-axle support, subframe, longitudinal or transverse beam module, but preferably of a front-axle support.

It is practical if the cast piece has fastening parts, particularly for fastening to the body of a vehicle, or one or more accommodations, screw-on locations and/or attachment locations for possible attached parts.

By means of the invention, a region on the node element in the form of the cast piece that can withstand great stress can thereby be made available, particularly for fastening to the body. According to the invention, the cast piece can be designed in keeping with the stresses. The required mechanical technological characteristic values can be achieved by means of the connection of the cast piece with at least one reinforcement element.

1: Chassis part, particularly a node element for connecting multiple hollow profiles in a frame construction, particularly for a motor vehicle, or a subframe for a motor vehicle, wherein the chassis part, particularly the node element or the subframe, has a cast piece that consists of at least one Al secondary alloy.

2: Chassis according to claim 1, wherein the chassis part, particularly the node element or the subframe, consists of a cast piece that consists of at least one Al secondary alloy.

3: Chassis part according to claim 1, wherein the Al secondary alloy is an Al—Si secondary alloy.

4: Chassis part according to claim 1, wherein the Al secondary alloy has a Si content of maximally 12 wt.-%, preferably of maximally 11 wt.-%.

5: Chassis part according to claim 1, wherein the Al secondary alloy has a Si content of at least 3 wt.-%, preferably of at least 5 wt.-%, particularly preferably of at least 7 wt.-%.

6: Chassis part according to claim 1, wherein the Al secondary alloy has a Mg content of maximally 0.6 wt.-%, preferably of maximally 0.5 wt.-%, particularly preferably of maximally 0.4 wt.-%.

7: Chassis part according to claim 1, wherein the Al secondary alloy has a Mg content of at least 0.2 wt.-%, preferably of at least 0.25 wt.-%.

8: Chassis part according to claim 1, wherein the Al secondary alloy has an Fe content of maximally 0.8 wt.-%, preferably of maximally 0.7 wt.-%, particularly preferably of maximally 0.6 wt.-%.

9: Chassis part according to claim 1, wherein the Al secondary alloy has an Fe content of at least 0.2 wt.-%, preferably of at least 0.3 wt.-%.

10: Chassis part according to claim 1, wherein the Al secondary alloy has a Cu content of maximally 0.6 wt.-%, preferably of maximally 0.5 wt.-%.

11: Chassis part according to claim 1, wherein the Al secondary alloy has a Mn content of less than 0.34*Fe^{-0.49} wt.-%.

12: Chassis part according to claim 1, wherein the chassis part, particularly the node element or the subframe, additionally has at least one reinforcement element.

13: Chassis part according to claim 12, wherein the cast part and the at least one reinforcement part are joined together with force fit, shape fit and/or material fit, preferably cast in one piece.

14: Chassis part according to claim 1, wherein the cast piece is produced using the die-casting method.

15: Chassis part according to claim 1, wherein the cast piece is produced using the gravity die-casting method.

16: Chassis part according to claim 1, wherein the cast piece has one or more reinforcement ribs, belts, beads, bulges, crosspieces and/or reinforcement perforations, particularly in the highly stress-resistant region.

17: Chassis part according to claim 1, wherein the cast piece is heat-treated.

18: Chassis part according to claim 1, wherein the cast piece is heat-treated in multiple stages, whereby the multi-stage character is preferably composed of solution annealing, subsequent rapid cooling, and final aging.

19: Chassis part according to claim 1, wherein the cast piece is solution-annealed at temperatures between 480° and 550° C., preferably between 490° and 540° C., particularly preferably between 520° and 540° C.

20: Chassis part according to claim 1, wherein the cast piece is solution-annealed for 1 to 5 hours, preferably 1 to 4 hours, particularly preferably 1 to 3 hours.

21: Chassis part according to claim 1, wherein the cast piece is aged at temperatures between 150° and 250° C.

22: Chassis part according to claim 1, wherein the cast piece is aged for 2 to 6 hours.

23: Chassis part according to claim 18, wherein the cooling rate amounts to more than 1.5 Kelvin/second, preferably more than 2 Kelvin/second, particularly preferably more than 5 Kelvin/second.

24: Chassis part according to claim 1, wherein the cast piece has an elongation to rupture (A) of at least 4%.

25: Chassis part according to claim 1, wherein the cast piece is heat-treated to achieve the state T6.

26: Chassis part according to claim 1, wherein the cast piece is heat-treated to achieve the state T5.

27: Chassis part according to claim 1, wherein the frame construction is a structural part of a vehicle body, such as, for example, a front-axle support, rear-axle support, subframe, longitudinal or transverse beam module, but preferably of a front-axle support.

28: Chassis part according to claim 1, wherein the cast piece has fastening parts, particularly for fastening to the body of a vehicle, or one or more accommodations, screw-on locations and/or attachment locations for possible attached parts.
